(19) United States
(12) Patent Application Publication
(10) Pub. No.: US 2026/0016364 A1
(43) Pub. Date: Jan. 15, 2026

(54) SYSTEMS, METHODS, AND APPLICATIONS FOR THE CONSTRUCTION OF BRIDGE DIGITAL TWIN

(71) Applicant: University of Florida Research Foundation, Inc., Gainesville, FL (US)

(72) Inventors: Alireza Adibfar, Gainesville, FL (US); Aaron Costin, Gainesville, FL (US)

(21) Appl. No.: 19/139,655

(22) PCT Filed: Dec. 14, 2023
(86) PCT No.: PCT/US2023/084010

§ 371 Date: Jun. 16, 2025

Related U.S. Application Data
(60) Provisional application No. 63/387,817, filed on Dec. 16, 2022.
(60) Provisional application No. 63/583,665, filed on Sep. 19, 2023.

(51) Int. Cl. G01M 5/00; G01G 19/03; G08G 1/09

(52) U.S. Cl. CPC G01M 5/0008; G01G 19/03; G01M 5/0041; G08G 1/09

(57) ABSTRACT

The present disclosure systems and methods for implementing a bridge digital twin. In this regard, one embodiment of such a method, among others, can be broadly summarized by executing a digital model of a physical bridge that is in use for carrying vehicular traffic; communicatively coupling a control system to one or more weight sensors that are positioned on the physical bridge or on a road that leads to an entrance to the physical bridge; receiving real-time sensor data acquired from the one or more weight sensors; and/or causing an alert to be displayed on a digital sign at the entrance to the physical bridge or on the road that leads to the entrance to the physical bridge when the one or more weight sensors detects that a weight of a vehicle approaching the physical bridge exceeds a threshold value for the physical bridge.

### CROSS-REFERENCE TO RELATED APPLICATION

This application claims priority to co-pending U.S. provisional application entitled, “Systems, Methods, and Applications for the Construction of Bridge Digital Twin,” having application No. 63/583,665, filed Sep. 19, 2023, and U.S. provisional application entitled, “Systems, Methods, and Applications for the Construction of Bridge Digital Twin,” having application No. 63/387,817, filed Dec. 16, 2022, each of which is entirely incorporated herein by reference.

### TECHNICAL FIELD

The present disclosure is generally related to techniques for implementing a virtual model of a physical bridge.

### BACKGROUND

There are more than 617,000 bridges across the United States. Based on the latest American Society of Civil Engineers (ASCE) infrastructure report card (2021), the overall grade of bridges has been improved since 2017, elevating from “D” as being in poor condition to “C” which is in mediocre condition, and deficient bridges have dropped from 9.1% to 7.5%. This report also indicates that 42% of bridges are more than 50 years old. Having more than 178 million trips over old or structurally deficient bridges raises concerns for the safety and reliability of the bridge and road transportation network. The ASCE estimates that the required budget for the repair and rehabilitation of these bridges would exceed $125 billion (B) USD. Furthermore, to improve the current condition, the annual expenditure on bridge rehabilitation needs to be increased from $14.4 B to $22.7 B. The increase in traffic, traffic backups, delays, and the emergence of new business hubs and wholesalers' warehouses across the United States exacerbates the concerns about bridges' health and reliability. The Federal Highway Administration (FHWA) (2018) reports that the freight industry has recently proposed an increase in the maximum load that could be carried by trucks on the roads. These changes would increase the rate of bridge fatigue and deterioration, increase their maintenance costs, and flag serious concerns for the safety of commuters.

### SUMMARY

Embodiments of the present disclosure systems and methods for the implementation of a bridge digital twin. One such system comprises a computer executing a digital model of a physical bridge that is in use for carrying vehicular traffic; one or more weight sensors positioned on the physical bridge or positioned on a road that leads to an entrance to the physical bridge; and/or a control system that is communicatively coupled to the one or more weight sensors and a digital sign positioned on an entrance to the physical bridge or positioned on the road that leads to the entrance to the physical bridge. In such a system, the control system is configured to display an alert on the digital sign when the one or more weight sensors detects that a weight of a vehicle approaching the physical bridge exceeds a threshold value for the physical bridge; and/or the computer is configured to receive real-time sensor data acquired from the one or more weight sensors and to predict a deterioration pattern for the physical bridge, using the digital model of the physical bridge.

The present disclosure can also be viewed as an additional system for implementing a bridge digital twin. Such an additional system comprises a computer executing a digital model of a physical bridge that is in use for carrying vehicular traffic; one or more weight sensors positioned on the physical bridge or positioned on a road that leads to an entrance to the physical bridge; and/or a control system that is communicatively coupled to the one or more weight sensors and a closable gate positioned on an entrance to the physical bridge or positioned on the road that leads to the entrance to the physical bridge. For such a system, the control system is configured to close the gate when the one or more weight sensors detects that a weight of a vehicle approaching the physical bridge exceeds a threshold value for the physical bridge; and/or the computer is configured to receive real-time sensor data acquired from the one or more weight sensors and to predict, using artificial intelligence, that the physical bridge is at risk of failure based on weight data of vehicles that have traveled over the physical bridge.

The present disclosure can also be viewed as a method for implementing a bridge digital twin. In this regard, one embodiment of such a method, among others, can be broadly summarized by executing, by a computing device, a digital model of a physical bridge that is in use for carrying vehicular traffic; communicatively coupling a control system to one or more weight sensors that are positioned on the physical bridge or on a road that leads to an entrance to the physical bridge; receiving, by the control system, real-time sensor data acquired from the one or more weight sensors; and/or causing, by the control system, an alert to be displayed on a digital sign at the entrance to the physical bridge or on the road that leads to the entrance to the physical bridge when the one or more weight sensors detects that a weight of a vehicle approaching the physical bridge exceeds a threshold value for the physical bridge.

In one or more aspects for such systems and methods, the control system is configured to reroute or stop traffic on the physical bridge in response to receiving the prediction for the physical bridge; the deterioration pattern comprises stresses or fatigue of bridge elements; the control system is configured to close a gate to the entrance to the bridge when the one or more weight sensors detects that a weight of a vehicle approaching the physical bridge exceeds a threshold value for the physical bridge; and/or the computer is configured to receive real-time sensor data acquired from the one or more weight sensors and to predict, using artificial intelligence, that the physical bridge is at risk of failure based on weight data of vehicles that have traveled over the physical bridge.

In one or more aspects, such systems and/or methods involve or comprise a database for storing sensor data acquired from the one or more weight sensors; wherein the real-time sensor data is transmitted to the computer from the database; wherein the database stores indications when the weight of a vehicle exceeds the threshold value for the physical bridge; predicting, by the computing device, a deterioration pattern for the physical bridge using the digital model of the physical bridge; sending, by the computing device, the prediction to the control system; and/or storing sensor data acquired from the one or more weight sensors in a database.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a framework of creating a Bridge digital twin using Intelligent Transportation Systems (ITS) and Bridge Information Modeling (BrIM) in accordance with various embodiments of the present disclosure.

FIG. 2 depicts the integration of transportation technologies for a bridge digital twin in accordance with various embodiments of the present disclosure.

FIG. 3 shows a flow chart for implementing a testing environment for a physical model of a bridge in accordance with the present disclosure.

FIG. 4 shows a flow chart describing operations of a weigh-in-motion system in accordance with various embodiments of the present disclosure.

FIG. 5 shows a bridge structure software model in accordance with various embodiments of the present disclosure.

FIGS. 6 and 7 show sensor data output and a plot of sensor data output of an Arduino microcomputer acting as a WIM station in accordance with the present disclosure.

FIG. 8 depicts a schematic block diagram of a computing device that can be used to implement various embodiments of the present disclosure.

### DETAILED DESCRIPTION

The present disclosure describes various embodiments of systems, apparatuses, and methods for the implementation of a bridge digital twin.

While the structural and physical assessment of bridges is vital for the ground transportation network, a recent review revealed that only a few articles focused on the evaluation of live load data for structural health monitoring of bridges. This lack of live load data integration could pose a potential risk to the infrastructure and end-users, including potential disasters. For example, on Oct. 11, 2019, a bridge superstructure collapsed over the under passing traffic in Wuxi-Jiangsu in China and killed three people. Assessments showed that this bridge was close to an industrial steel manufacturing area and was exposed to the frequent overweight passage of trucks for years. As the bridge fatigue was continuously developed, eventually, the passage of an overweighted truck led to extra momentum on the superstructure, and the bridge could not withstand this force and collapsed. Three people died, and two were severely injured in this accident. This disaster could have been prevented by continuously monitoring and controlling overweight live load passage over the bridge. An exemplary system of the present disclosure could help in the proactive planning and operation of bridges to prevent such disasters.

Building Information Modeling (BIM) has shown promising results for integrating building data to manage buildings' lifecycle in the construction industry. Recently, its development for bridges, known as Bridge Information Modeling (BriM), has considerably helped bridge engineers, and they can offer sharpened designs for bridge construction, rehabilitation, and repairs. As BIM is an exact model of an asset with embedded data, researchers developed its capabilities to work in a real-time environment. The real-time data can flow from sensors, control systems, or any other system into the model and make the model data-rich, also called “Digital Twin.” The digital twin is the virtual representation of the physical structure that mirrors all elemental specifications, such as structure, functionality, and performance. In the technical sense, digital twin is a cyber-physical system (CPS) that connects real-world physical objects with integrated sensing, modeling, computation, control, and networking. Accordingly, digital twins can use real-time and historical data to represent the past and present and simulate predicted futures. As the digital twin is scalable, it can represent a single element, a product, or a system. Sofia et al. (2020) describe a digital twin as a digital replica of a complex system with a high level of fidelity. See Sofia, H., Anas, E., and Faiz, O. (2020). “Mobile Mapping, Machine Learning and Digital Twin for Road Infrastructure Monitoring and Maintenance: Case Study of Mohammed VI Bridge in Morocco”. Proceedings of 2020 IEEE International Conference of Moroccan Geomatics (Morgeo), 11-13 May 2020, Casablanca, Morocco, Morocco. DOI: 10.1109/Morgeo49228.2020.9121882. As a digital twin is based on the virtual model of assets, the embedded information could be shared remotely on cloud networks which amplify its capabilities.

In theory, the making of a bridge digital twin entails finding a physical bridge, modeling the physical bridge in a virtual environment, attaching sensors to the physical bridge, enabling real-time connectivity to the virtual environment, and updating the virtual model to reflected real-time sensor data. In practice, the integration of disparate data sets is quite complex. It is important to note that a virtual, or 3D model, in and of itself is not a digital twin. Digital twin requires the continual updating of the model to reflect current conditions, which typically requires the use of sensors that are connected to the system producing the digital twin. Thus, the real-time sensor data will be reflected in the virtual model. However, the digital twin is not meant to be complete since it is impractical to contain all real-world information, and it is more beneficial to focus on limited scopes and uses.

A digital twin has pressing, yet practical, applications for bridge management systems (BMS). The augmentation of real-time traffic data into the BrIM model can help the operating entities detect overweight vehicles in an immersive environment and take early actions against their passage over critical bridges. These vehicles can also be detected in real-time and stopped before passing over the bridge. A key component of cyber-physical system is the use of the internet of things (IoT), which are embedded sensors that connect physical objects with the internet. Thus, a bridge digital twin provides the framework needed to interconnect various bridge systems, sensors, and databases that provides real-time feedback of the current conditions and responses of the physical bridge, which are reflected simultaneously in the virtual 3D model. For example, an exemplary bridge digital twin can contain a virtual 3D geometric model that reflects the current bridge loads and conditions; provide real-time feedback on conditions and of imminent dangers; and incorporate all the other data streams from other sources needed for artificial intelligence (AI) capabilities that can result in better prediction and prevention. A major value of a digital twin is the creation of new knowledge that the integration of the information resources creates. The virtual environment enables BIM, augmented reality (AR), and virtual reality (VR) that creates an immersive world of bridge data. AR provides another means to visualize bridge data that can be useful for various management applications such as overlaying (i.e. augmenting) the virtual model on the physical model to compare the two.

Structural Health Monitoring (SHM) via sensors and visual inspections is the primary source of data about bridges which can go beyond just the health of bridges. For example, monitoring of icing condition of bridge deck, which is beyond the health of the bridge, can generate important information to be relayed to drivers. Accordingly, SHM systems deploy sensors and techniques to monitor the current condition and detect structural damage, degradation, and anomalies to estimate its remaining useful life. There are a variety of SHM systems that employ a variety of mechanical, physical, chemical, and environmental sensors, including IoT enabled sensors. These sensors capture bridge inputs (loading and environmental conditions) and responses that are subsequently post-processed to assess the condition of the bridge. SHM systems may utilize a calibrated finite element model of the bridge in conjunction with sensor measurements to perform predictive response condition assessment analysis. However, the visual inspection methods are risky, challenging, and require working in unsafe conditions such as post-disasters. Moreover, the collected data are not entirely reliable as they depend highly on humans and their judgment and experience. Thus, the inspection results may be incomplete, subjective, and prone to error. As such, current SHM data are not sufficient for making an inclusive decision about a bridge condition.

Intelligent Transportation Systems (ITS) are a set of integrated electronic sensors, devices, and interfaces that perform various forms of function to enhance transportation application. Such applications have the ability to automatically capture transportation data and provide a reliable stream of online data which is used in real-time actions and informed decisions. The sensors could be mechanical or vision-based sensors that capture electronic signals and use firmware to convert them into data and store them in their database. The system then uses communication media for data transfer, and eventually, a Graphical User Interface (GUI) represents the data in a visual and understandable format. Examples of ITS include weigh-in-motion, traffic signal control systems, and traffic/mobility management. The benefit of utilizing ITS is it provides the sensors, data streams, and processes needed for insight on bridge loading for the digital twin.

Geographic Information Systems (GIS) are the collection of systems, databases, technologies, and processes used to visualize and represent the physical features of the earth. What initially started as simple maps and terrain layers, GIS has evolved to incorporate a variety of data streams to enhance analysis, visualization, and simulation of the geospatial data. Incorporating geodata into 3D models enables the creation of Digital Terrain Model (DTM) and Digital Surface Model (DSM). Global imagery maps, such as Google Maps, Google Earth, and OpenStreetMap, can overlay raster images of the data. Software, such as ArcGIS, can enable the interaction and manipulation of the data. With the various data sources and software capabilities, GIS maps provide countless interactive applications, including population densities, population habits, traffic patterns, climate impacts, and historical events. Bridges rely heavily on geospatial and topographic information, thus GIS is an integral part of planning, design, construction, and operations of bridge projects. Essentially, GIS puts a digital twin on the Earth and allows for project digital twins to be “combined” and augmented (e.g., Smart Cities).

Therefore, in accordance with various embodiments of the present disclosure, the augmentation of such sensor data and data streams, such as live load traffic data, to a bridge digital twin structural model can improve the evaluation of dynamic stresses, strains, and fatigue of the bridge elements. Evaluation of historical data is easier with this approach and can be extended to a broader scale via Geographic Information System (GIS) maps. This augmentation enables the development of proactive plans for the operation, maintenance, and management of bridges. Additionally, new inspection methodologies are becoming more reliant on digital inspections such as using drones with cameras and 3D scanning for capturing data, and then they use image processing software for interpretation of the results. As the model can be designed to receive material parameters and history information such as concrete, steel, and pre-stressed members information, the analysis, interpretation, and decision making would become much more enhanced. Sensors are great sources of data to keep digital twin data updated through regular operations or after severe events such as earthquakes or hurricanes. Digital twins have the capabilities to sustainability and resilience of the structures.

For example, pavement and surfaces generally have a lifespan of 10-30 years, depending on the material, geographical location, and frequency of use, and upkeep. Like bridge and other infrastructure inspection, when lacking a robust pavement management system, the maintenance and repair of these structures are typically performed in a reactive and manual effort. Sierra et. al (2022) develop a cognitive digital twin by capturing photographic images and video using unmanned aerial vehicles (UAVs), using photogrammetry to convert the data into a reality model, and implementing machine learning neural networks to identify various defects, effectively becoming a cognitive digital twin. See Sierra, C., Paul, S., Rahman, A., and Kulkarni, A., “Development of a Cognitive Digital Twin for Pavement Infrastructure Health Monitoring,” Infrastructures, 7(9), 113 (2022). Although there are few technical challenges with the UAV regulations and constraints with the quality of photos required, this study demonstrates the feasibility of using aerial data to identify pavement defects with moderate accuracy while being much more cost effective than manual inspections. The practicality of the identification enables less effort and time for the initial screening of defects that can then be followed up with more rigorous manually inspections.

Having the passing vehicles communicate directly with the bridge digital twin is another source of information that can be used in the overall bridge operations and maintenance. For example, vehicles can share current loading and diagnostic information while the bridge can notify the vehicle of upcoming traffic and potential hazards. The communication between vehicles to bridges and transportation infrastructure, named vehicle-to-infrastructure (V2I), is an emerging technology trend. Khan et al. (2019) reviews of current status and provides the future directions of how connected vehicles can provide improved safety, enhanced environmental sustainability, better traffic management, increased mobility, and planning. See Khan, S. M., Chowdhury, M., Morris, E. A., and Deka, L, “Synergizing Roadway Infrastructure Investment with Digital Infrastructure for Infrastructure-Based Connected Vehicle Applications: Review of Current Status and Future Directions,” Journal of Infrastructure Systems, 25(4) (2020). Wang et al. (2020) use a digital twin framework to test the data exchange feasibility and quality for exchanging data between connected vehicles, which yielded satisfying results. See Wang, Z., Liao, X., Zhao, X., and Han, K., “A Digital Twin Paradigm: Vehicle to Cloud Based Advanced Driver Assistance Systems,” Proceedings of 2020 IEEE 91^{st} Vehicular Technology Conference (VTC2020-Spring), May 25-28, Antwerp, Belgium (2020).

As accessing the real-time Weigh-In-Motion (WIM) data and bridge structural drawings are not readily available, a scaled version of a bridge and WIM system was constructed to develop a bridge digital twin for testing and evaluation. In this process, the passage of commercial vehicles are simulated using model trucks, and their weight is captured with Arduino sensor systems and registered in a database. Overweighted vehicles can be detected in real-time through the system, and a warning sign notifies the controller (control system) about the approaching vehicle for further actions. Accordingly, an exemplary system of the present disclosure can help improve bridges' lifecycle data integration and management, improve safety, preserve the bridge structure, and reduce maintenance costs. The integration of SHM and WIM data under the umbrella of a bridge digital twin can enhance the accessibility of bridge lifecycle data which helps in the improvement of the efficiency and accuracy of engineering analysis and design. The system is also scalable as it can be mapped on a network through GIS. The abundance of data in this system helps apply other methods such as artificial intelligence and machine learning which significantly enhances the quality of forecasting and planning in various embodiments of the present disclosure.

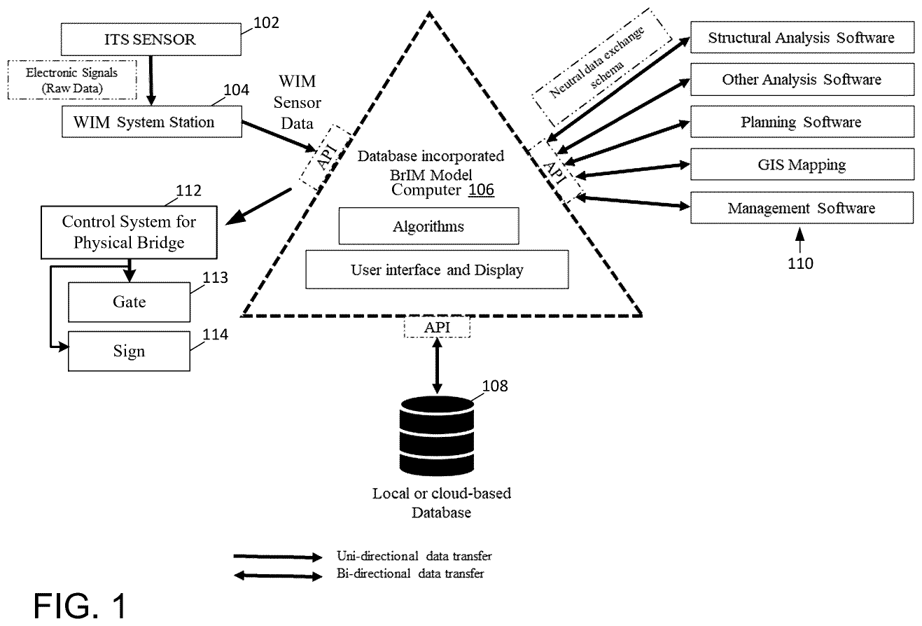

Referring now to FIG. 1, a framework of creating a bridge digital twin using Intelligent Transportation Systems (ITS) (e.g., WIM system station 102 and ITS sensor 104) and BrIM is illustrated in accordance with various embodiments of the present disclosure. As illustrated in FIG. 1, WIM data are imported into a computer device executing the BrIM model (“BrIM Model Computing Device”) 106 using Application Programming Interfaces (APIs). For example, the figure illustrates that intelligent transportation systems (ITS) and corresponding sensors are integrated in the main system using an application program interface (API). WIM data could also be associated with a database 108 integrated with the BrIM model. Other sensors could also be integrated into the BrIM model computer 106 using the same method. After the data is registered or imported into the BrIM model, other software such as structural analysis software 110 can be connected to the BrIM model through the development of APIs. Eventually, the system and its components simultaneously communicate with the physical asset or bridge in a real-time manner via a control system (“controller”) 112 and create the digital twin of the bridge. Accordingly, in various embodiments, the control system 112 can control gate(s) 113 or sign(s) 114 on the physical bridge to slow or reroute traffic on the bridge based on real-time or live conditions on the bridge.

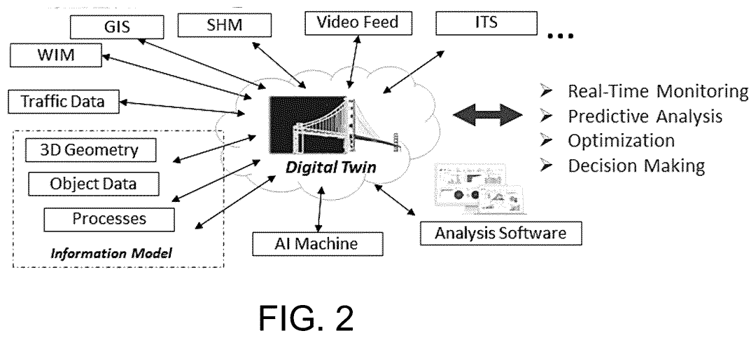

The main computer-based system 106, denoted by the dashed triangle, contains the user interface, virtual model (in this case a Bridge Information Model, or BrIM), and any algorithms needed to manipulate, analyze, and make predictions based on the data. To fully harness the predictive analysis capabilities, artificial intelligence (AI) and machine learning (ML) techniques for data mining and processing require abundant data, so the digital twin framework must incorporate additional data sets, such as historical data and additional software tools. The sensors and software displayed in the figure are only one specific application of a digital twin, and the types and configurations of integrations are endless. The digital twin framework can utilize numerous combinations of technologies. Fortunately, the technology needed to create a bridge digital twin already exists, as illustrated in FIG. 2 that lists data and information systems involving WIM, GIS, SHM, live video feeds, ITS, AI, and BIMs. The integration of the various technologies is what is required to realize a bridge digital twin in the industry. Such technologies used in the creation of a bridge digital twin can include Building Information Modeling (BIM), Structural Health Monitoring (SHM) and finite element analysis, Intelligent Transportation Systems (ITS), and Geographic Information Systems (GIS).

As accessing the real-time WIM data and bridge structural drawings are not readily available, this research constructed a scaled version of a bridge and WIM system to develop the bridge digital twin for testing and evaluation. In this process, the passage of commercial vehicles has been simulated using model trucks, and their weight has been captured with Arduino sensor systems and registered in a database.

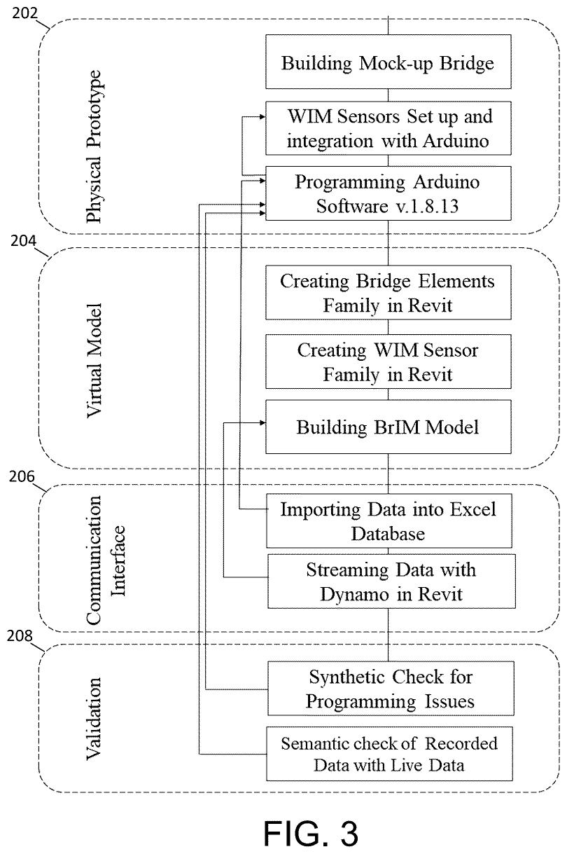

As discussed previously, for research and testing purposes, a mock-up bridge or physical prototype 202 is built as the physical model to create the test environment, as illustrated in a flowchart of FIG. 3. This bridge is a representation of a bridge structure and is not a scaled model of any real-world bridge. An HX711 load cell represents the weighing sensor to simulate the WIM system, and the Arduino Mega microcomputer is selected to collect sensor data (e.g. weight measurements) and simulate the local WIM station. The computer device (executing the BrIM model) (“BrIM model computer”) 106 and the Arduino WIM system can communicate through Communication Port (COM port) and transfer data regarding attributes about the physical object, such as lifecycle data and weight data. For transferring the weight data detected by the WIM system 104 to the BrIM model computer 106, the Arduino is programmed through the Arduino 1.8.13 interface. The transmitted data are then stored in an Excel database 108 associated with the BrIM or virtual model 204.

For creating the virtual model 204, a BrIM model of the sample bridge is created using Autodesk Revit (version 2020). Each bridge element, such as piers, girders, and deck, is modeled in Revit family as separate objects and then merged in the Revit Structural environment. Accordingly, each object in the model, such as a girder, handrail, or bearing, can have their real-life object information attached to it, such as the make, model, history, and physical properties. Thus, BIM provides three aspects of the digital twin: 1) 3D geometry, 2) physical object data, and 3) processes.

The WIM or ITS sensor 102 is also separately modeled, and the required information fields are defined for it. There are three primary motivations behind creating individual families for each element category. First, to create a family with a geometric detail that is close to the actual model and can be furtherly developed in the future; Second, to make the required data fields in the family properties so the object would be able to receive data; Third, to prepare a flexible context for augmentation of more data into each element in the future.

After creating the BrIM model, a communication interface 206 is designed to import sensor data into the database 108 and to stream data from the database 108 to the BrIM model 204. Accordingly, for testing purposes, a Dynamo script (using Dynamo version 2.3) is developed to read the data in real-time from the Excel database and send it to the WIM sensor family in the model. The virtual WIM sensor responds to the received weight according to its thresholds and scenarios, further discussed below.

The model is then validated (208) through both internal and external validation. For internal validation, the communicated data between the physical system and the BrIM model computer 106 are evaluated using unit testing to determine if the data could be successfully detected and stored in the database 108 while maintaining their full semantics. For external validation, different model vehicles with different weights are used. Initially, a reference weight is used to calibrate the WIM system 104 and define the threshold of the allowed weight versus the overweight. Then, model vehicles are passed over the mock-up bridge, and their weight is detected, reported, and recorded in the system. Finally, the system is tested to ensure all the scenarios are being run correctly.

For physical prototyping 202, a Maker Beam aluminum beam set was selected as the primary tool for building the bridge mockup. The bridge was configured to have a simple shape to satisfy the primary needs for the development and validation of the research. As the loadcell needed to be installed underneath the deck, aluminum sheets were used as the deck due to their flexibility and strength. Two gantries were attached to the bridge to host the small Liquid Crystal Display (LCD), which represents the Variable Message Sign (VMS), and a Light-emitting diode (LED), which could go green or red to indicate the status of the passage. However, due to technical issues and problems with the available wire sizes and length, it was not possible to mount the LCD and the LED on top of the gantry. Therefore, these devices were fixed to the side of the bridge close to the load cell location, but gantries were maintained for future uses.

To build a mock-up of the WIM system 104, Raspberry Pi and Arduino were identified as suitable choices, with Arduino selected for this particular effort. For sensors and microcomputers, a 5 kg load cell and an HX711 board were selected to detect weight and translate the electrical signals into digits that could be read by the Arduino microcomputer. Arduino MEGA 250 microcomputer was programmed with the Arduino software (version 1.8.13) to receive and broadcast data into the BrIM model computer 106. The communication rate for the Arduino, known as Baud Rate (BR), was set to 9600 as it is the most compatible BR with the HX711 library. For calibration, a digital scale was used to find the exact weight of a model truck, and then the model truck was used as a reference weight for the sensor's calibration. The calibration data can be registered into Arduino's EEPROM to maintain the calibration setting every time it loads up.

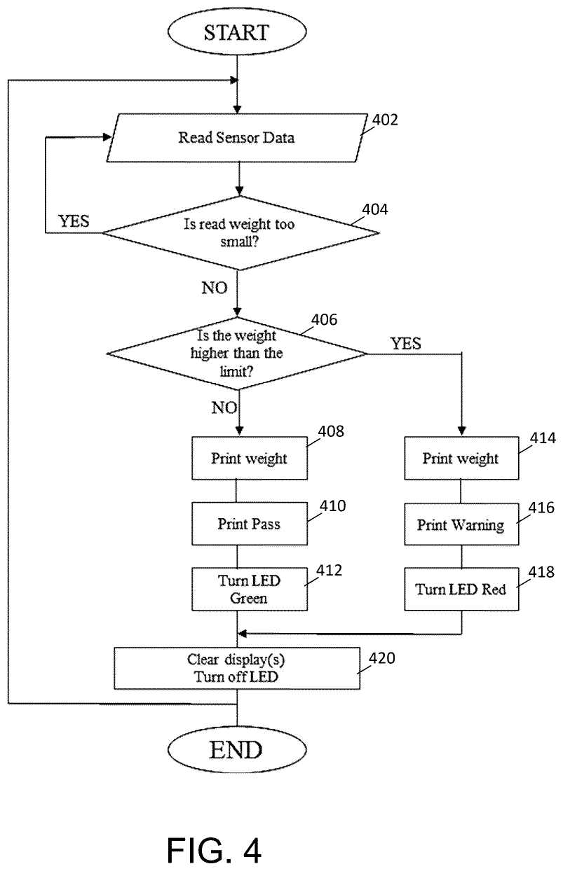

After the load up and calibration, the WIM system 104 starts to receive and read (402) the weight data from the sensor 102. As illustrated in the flow chart of FIG. 4, after detecting a weight, the system compares (404) it with the minimum threshold set during the calibration. If the weight is smaller than the minimum threshold, which might be due to the thermal deflection of the deck or any events other than a passage of a standard model car, the system will not continue through the flowchart and returns to the beginning and waits for the next weight to be detected. If the detected weight is heavier than the minimum threshold, the program jumps into a second part or branch of the flow chart. It first compares (406) the weight with the maximum allowed weight that has been defined for the program. The vehicle will be recognized as safe if the detected weight is below the max weight. In this case, the weight will be displayed or “printed” (408) on the LCD and the COM output, the “Pass” message will show (410) on the LCD, and the LED light goes green (412). Similarly, if the detected weight exceeds the maximum set amount, it will be detected as a harmful vehicle. Its weight will be recorded and “printed” or displayed (414) both on the LCD and the COM port, a warning message as “STOP” will be shown (416) on the LCD, and the LED will turn (418) red to prevent the vehicle from passing over the bridge. In both cases, the displays will then be cleared (420) and data will be sent to the database 108 to be stored for future references and be considered as historical data. These data could be used by other analysis software for further analysis, such as performing machine learning and artificial intelligence algorithms to find patterns for preventive planning. For example, artificial intelligence can be utilized for predictive analysis of failure and maintenance, to assist in what-if scenarios, and automatic routing of traffic based on dynamic loading.

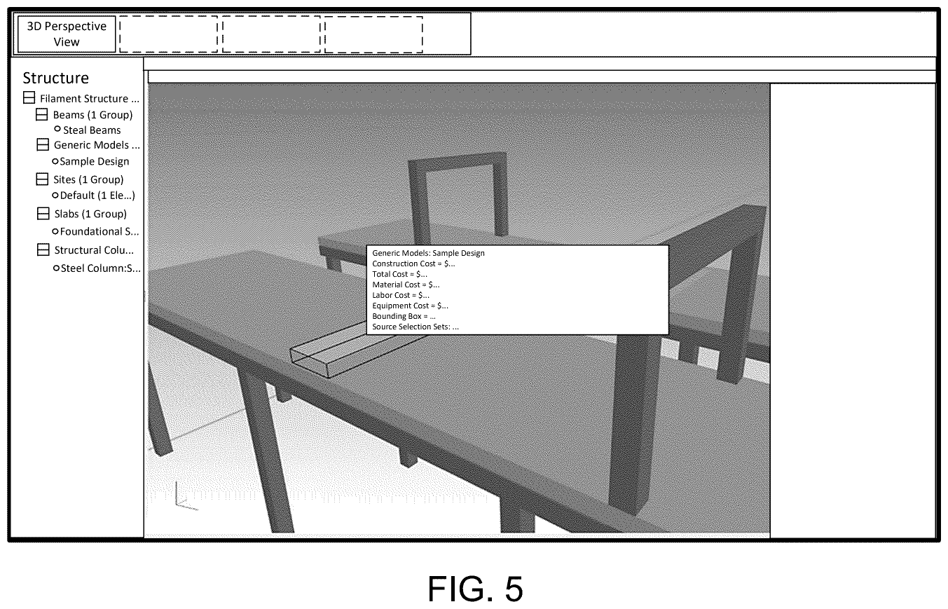

For BIM modeling, as mentioned earlier, the BrIM model of the bridge was created using the Revit software. The columns and beams were defined as structural columns and structural framing families in the Autodesk Revit (Version 2020). Level of Details (LOD) defines how detailed the elements of a BIM model have been designed and drafted in a Computer-Aided Design (CAD) software. Due to the goals and objectives of this disclosure, all the families were developed in LOD of 200, meaning they are just a rough representation of the element (deck, girder, column, and loadcell) without having details about the connection type or fixtures. Two sensors were created in the Revit family to represent the WIM sensors on the bridge, and two data fields were embedded in the WIM sensor family. Thus, the first field receives and retains the weight of the last passed vehicle from the sensor connected to the computer's COM port. The second field contains the maximum weight that is allowed to pass over the bridge. The first field receives the data and compares it with the second field to find out if the vehicle is passing within the allowed range, or if it is an over-weighted vehicle. After making the families in Autodesk Revit Family, the elements were imported into the Revit environment and assembled to start the modeling. The bridge structure was modeled using the Revit 2020 structural environment, and the sensors were added to them. The gantries were also modeled to provide a complete representation of the bridge, while they do not have any structural role in the model. The bridge structure model was then exported as an Industry Foundation Classes (IFC) (Version 4) file and was retrieved in other software such as Solibri (Version 04/2020) and Bexel Manager (version 20) to ensure the developed families will maintain their geometrics and semantics during transfer. A sample of the bridge structure model opened by Bexel Manager software can be viewed in FIG. 5.

The weight data can be read directly from the COM port, illustrated on the BrIM model, and stored in the database 108, or they can be first associated with a database 108 and then read by the BrIM model 204. As the real-world WIM systems use the latter approach, meaning that the WIM system 104 stores the data into a database 108 so their specific software could later use it, this approach is selected to make a more realistic scenario. To read the data into the BrIM model 204, an Excel file (Version 2016) was created as a database and was integrated with the BrIM model through programming. The Arduino data were read from the COM port and stored in an Excel file using the Data Streamer add-in installed on the Excel to read the COM port data.

For programming the communication interface, Dynamo (Version 2.3) was used as the programming platform that reads & transfers data into the BrIM model in real-time. After implementing the algorithms in Dynamo, the BrIM model received weight data in real-time and acted according to the algorithm defined for it. If a vehicle passes over the bridge within the normal limits and the system detects it as a safe vehicle, the sensor on the BrIM model will turn green, and “Vehicle Pass” is displayed over the sensor in the model. If a vehicle passes with overweight over the sensor, it will be detected, and an algorithm will be run to turn the sensor's color into red. A warning message “Warning: Overweight Detected” will be displayed over the sensor. Further, in various embodiments, using the capabilities of artificial intelligence, sensor data can be used to predict the structural health of the physical bridge and the control system 112 of a physical bridge can use the bridge digital twin 204 (e.g., BrIM computer model) as a decision-making tool.

Accordingly, in various embodiments, an exemplary system of the present disclosure comprises a digital model 204 of a physical bridge that is in use for carrying vehicular traffic; one or more weight sensors 102 positioned on the physical bridge or positioned on a road that leads to an entrance to the physical bridge; a control system 112 that is communicatively coupled to the one or more weight sensors 102 and a digital sign 114 positioned on an entrance to the physical bridge or positioned on the road that leads to the entrance to the physical bridge; and wherein the control system 112 is configured to display an alert on the digital sign 114 when the one or more weight sensors 102 detect that a weight of a vehicle approaching the physical bridge exceeds a threshold value for the physical bridge. In various embodiments, the control system 112 is further configured to predict, using artificial intelligence and a BrIM model 204, that the physical bridge is at risk of failure based on a prediction of the BrIM model 204 from weight data of vehicles that have traveled over the physical bridge. Accordingly, in various embodiments, the control system can be alerted to the prediction so that it can reroute and direct traffic around the physical bridge.

Additionally, in various embodiments, an exemplary system comprises a digital model 204 of a physical bridge that is in use for carrying vehicular traffic; one or more weight sensors 102 positioned on the physical bridge or positioned on a road that leads to an entrance to the physical bridge; a control system 112 that is communicatively coupled to the one or more weight sensors 102 and a closable gate 113 positioned on an entrance to the physical bridge or positioned on the road that leads to the entrance to the physical bridge; and wherein the control system 112 is configured to close the gate 1 (and redirect traffic) when the one or more weight sensors 102 detects that a weight of a vehicle approaching the physical bridge exceeds a threshold value for the physical bridge. In various embodiments, the control system 112 is further configured to predict, using artificial intelligence and the BrIM model 204, that the physical bridge is at risk of failure based on a predicted characteristic or condition/fault/degradation/deterioration pattern of the BrIM model 204 from the weight data of vehicles that have traveled over the physical bridge.

A bridge digital twin has the potential to help in improvement of bridge maintenance plans which results in savings in cost and time. The consolidated set of data could be further processed through AI and ML methods to enhance the quality and extensiveness of the analysis results. Currently, widely applied methods of structural health evaluation are the reliability theory, analytic hierarchy process (AHP), fuzzy theory, and genetic algorithm. The application of AI and ML can enhance the quality and accuracy of damage detection compared to traditional methods. The pattern recognition methods will help in improving the optimization of maintenance plans and tailoring them based on the needs of individual bridges considering their geographical location, weather condition severity, traffic density, and expected level of service. Current prediction methods used in SHM have about a 79% accuracy of predication and those with AI are increased to 90%. Assaad and El-adaway (2020) has a higher accuracy to 91.44%. See Assaad, R., & El-adaway, I. H. (2020). Bridge infrastructure asset management system: Comparative computational machine learning approach for evaluating and predicting deck deterioration conditions. Journal of Infrastructure Systems, 26(3), 04020032.

By utilizing real-time data to update the bridge digital twin model with the current loading conditions, an even higher accuracy is likely in accordance with various embodiments of the present disclosure. One of the greatest benefit of predictive analysis for preventative maintenance is the ability for the optimization of the planning and use of the limited funds. Not only does the availability of increased data via a digital twin provide the ability for decision support, but predictive analysis could identify how best to spend the funds.

For results and validation, the present disclosure used a mock-up of a bridge as a case model to validate the data exchange and fusion process. Validation is performed in two phases as internal and external validation to ensure the flawless transfer of data from Arduino into the computer. Using 50-unit tests, 47 were passed successfully. The remaining three were checked and modified. The transferred data could retain their semantic values during the exchange. The system was first checked for any loss of data during the exchange by putting different weights on the load cell and checked for their detection in the system, in which no loss of data occurred. Then, the system's reliability was measured by monitoring the number of successful exchanges that reflected 100 percent reliability by receiving all the detected weights in the database. Synthetic checks have been constantly performed to find the problems with the programming, and all of the issues were fixed. This step of validation improved the algorithm of detection and reliability of the simulated WIM system. Then, the semantics of the exchanged data within the database were checked. The review of database records showed that all the recorded data retained their original semantic data. Therefore, the algorithms can exchange the data within the expected quality.

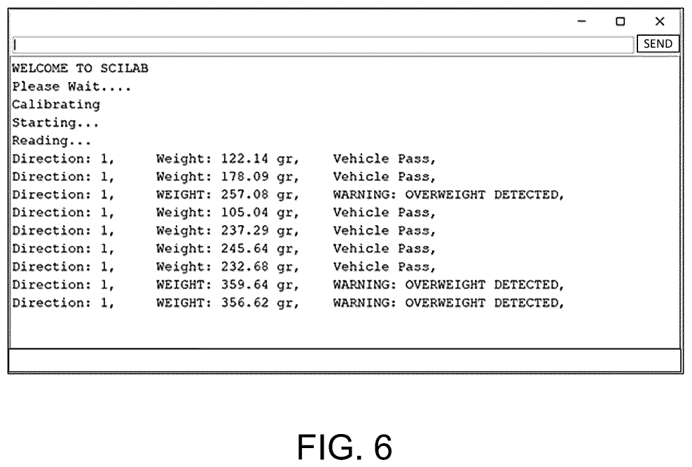

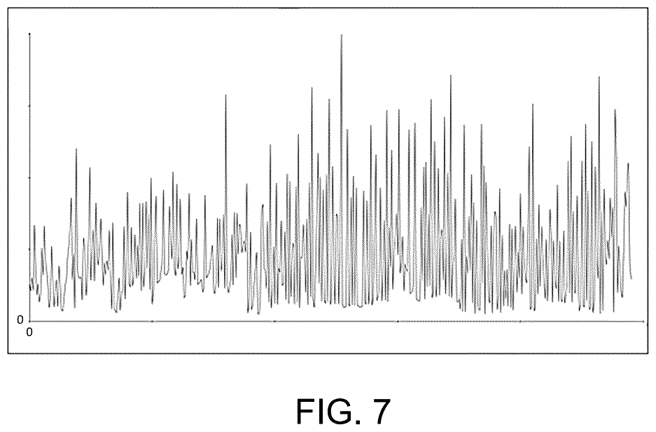

The data transferred from the Arduino (e.g., WIM station) into the computer's (e.g., BrIM model computer's) COM port can be viewed in the serial viewer of Arduino software. The displayed data can be configured through the Arduino program to print characters and readings as desired. FIG. 6 shows a sample of data output on the Arduino interface. Data can also be plotted through the software features, as shown in FIG. 7. The data transmitted from the Arduino microcomputer and received at the COM port could be extracted through the programming to be viewed by other software. It should be considered that the format of the received data is a function of the programming done through the Arduino interface, and the order of input data could not be changed inside the Dynamo platform. Therefore, the Arduino code can be scripted based on a flowchart and proper formatting that yields the maximum information. It is suggested to follow Comma Separated Values (CSV) format to delineate different parts of data to be correctly extracted by other software.

After performing the internal validation and evaluating algorithms, external validation was performed. For the external validation, five different types of vehicles were used in the form of model trucks and cars, and different loads were put on them and passed over the bridge. In every attempt, the system could successfully detect the vehicle's weight, compare it with the embedded algorithm, take proper action for flagging the overweight vehicle or let the vehicle continue passing over the bridge. Fifty replications with different loadings were performed. They could be successful in forty-seven attempts, highlighting the level of reliability for this system, which shows the system is 94 percent reliable. The software system was also able to read the data and demonstrate the load status by changing the color of the WIM sensor on the model. Both internal and external validations show that the system has a high level of reliability and yields trustable results, ensuring the proper transfer of data within the proposed system.

Arduino and compatible sensors were used to prepare the physical model of sensors and facilitate data transmission. Although Arduino is good for quick prototyping and ease of use, more complex microcomputers are contemplated for other applications to enable more senor compatibility and simultaneous data streaming. Further, interoperability is an important element for the development of a bridge digital twin since there are many available sensor systems and software platforms to create and represent data. Most of the sensor systems have their unique structure and output formatting. Accordingly, various embodiments of the bridge digital twin system should communicate with different systems and exchange information without much effort on the end-user. Thus, the development of neutral data exchange platforms can help support the interoperability of bridge digital twins. For example, Industry Foundation Classes (IFC) is a successful neutral data exchange platform that considerably helped integrate and communicate different software platforms, such as an IFCSensor which is currently used to integrate standard sensors. Accordingly, development of IFC for specific sensors such as WIM and other ITS devices can help the interoperability of ITS systems with a bridge digital twin. The application of artificial intelligence principles and the development of machine learning algorithms can significantly help control the exchanged data. WIM systems produce vast amounts of data every day. Because all the structural inspections and SHM data could be associated with the bridge's digital twin, there will be many layers of data available for performing machine learning principles on them, which can uncover deterioration patterns and their most possible causes, which are precious information for improving the preventive planning and management of bridges.

Exemplary bridge digital twin systems and methods can help the bridge's lifecycle management and save considerable time and money through scenario planning. Monitoring of live load status over bridges and their association with SHM data can help better assess the bridge condition. The data can be stored in a database associated with the bridge digital twin, and engineers and designers can later have access to an extensive amount of historical live load data. Through this approach, various sensors could stream their data into the digital twin of the bridge. Neutral data exchanges, such as IFC and the Web Ontology Language (OWL), can be integrated with the bridge digital twin to communicate sensor data, removing the obstacles toward data integration. This approach can improve the integration and utilization of bridge lifecycle data. The bridge digital twin and BrIM data can be mapped into GIS. Planners can then evaluate the bridges at a network level and have an advanced perspective for decision-making about funds and resource allocation based on the needs, priorities, and constraints.

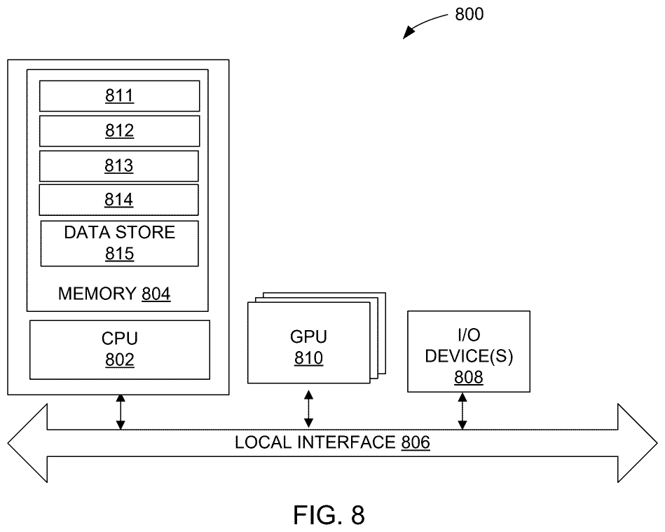

FIG. 8 depicts a schematic block diagram of a computing device 800 that can be used to implement various embodiments of the present disclosure, such as a control system 112 or a BrIM model computer 106. An exemplary computing device 800 includes at least one processor circuit, for example, having a processor 802 and a memory 804, both of which are coupled to a local interface 806, and one or more input and output (I/O) devices 808. The local interface 806 may comprise, for example, a data bus with an accompanying address/control bus or other bus structure as can be appreciated. The computing device 800 may further include Graphical Processing Unit(s) (GPU) 810 that are coupled to the local interface 806 and may utilize memory 804 and/or may have its own dedicated memory. The CPU and/or GPU(s) can perform various operations such as image enhancement, graphics rendering, image/video processing, and any of the various operations described herein.

Stored in the memory 804 are both data and several components that are executable by the processor 802. In particular, stored in the memory 804 and executable by the processor 802 are code for modeling a physical bridge 811, predicting bridge conditions 812, machine learning or artificial intelligence code 813, and/or controlling bridge operations 814. Also stored in the memory 804 may be a data store 815 and other data. In addition, an operating system may be stored in the memory 804 and executable by the processor 802. The I/O devices 808 may include input devices, for example but not limited to, a keyboard, mouse, etc. Furthermore, the I/O devices 808 may also include output devices, for example but not limited to, a printer, display, etc.

In brief, the present disclosure has successfully demonstrated the feasibility of developing a bridge digital twin. Although aspects of this study used data that have been generated through the manual passage of the model vehicles over a mock-up bridge, real-world WIM data can be used to test the embedment of real WIM data in the digital twin of the bridge. Additionally, current WIM systems are typically placed thousands of feet away from the bridge, which gives adequate time for overweight vehicles to pull off prior to crossing. In addition to using WIM, it is expected that additional weight sensors can be placed on the bridge to monitor and record the real-time loads.

As such, the present disclosure is concerned with creating a digital twin for bridges (horizontal construction), which is different than developing a digital twin for traditional buildings (vertical construction). Design and monitoring of loading, specifically live loads, is one of the main differences between these two structures. While the amount of live load in vertical structures is limited, the live load of horizontal buildings can vary, and even uncontrolled passage of the over-weighted live loads can lead to the collapse of a bridge structure. Modeling the structures is another difference in vertical and horizontal buildings. Vertical buildings usually have more details in their architectural and structural design, while in horizontal buildings the amount of architectural work is usually minimal and most of the elements are structural elements. Mechanical, Electrical, and Plumbing (MEP) details are usually more complex in vertical buildings. While on the other hand, horizontal buildings are equipped with displacement, tension, and strain sensors. Therefore, identifying the source of data and type of sensors that should be connected to the digital twin is important. Heating, ventilation, and air conditioning (HVAC) design and monitoring is an important element in the vertical building, while in horizontal structures, some systems such as HVAC are not applicable. Exhaust fans and turbines are being used in some tunnels which are different than HVAC and require different configurations in their embedment in the digital twin.

One or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

A number of embodiments of the invention have been described. Nevertheless, it will be understood that various modifications may be made without departing from the spirit and scope of the invention. Accordingly, other embodiments are within the scope of the following claims.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A system comprising:
a computer executing a digital model of a physical bridge that is in use for carrying vehicular traffic;
one or more weight sensors positioned on the physical bridge or positioned on a road that leads to an entrance to the physical bridge;
a control system that is communicatively coupled to the one or more weight sensors and a digital sign positioned on an entrance to the physical bridge or positioned on the road that leads to the entrance to the physical bridge;
wherein the control system is configured to display an alert on the digital sign when the one or more weight sensors detects that a weight of a vehicle approaching the physical bridge exceeds a threshold value for the physical bridge; and
wherein the computer is configured to receive real-time sensor data acquired from the one or more weight sensors and to predict a deterioration pattern for the physical bridge, using the digital model of the physical bridge.

2. The system of claim 1, wherein the control system is configured to reroute or stop traffic on the physical bridge in response to receiving the prediction for the physical bridge.

3. The system of claim 1, wherein the deterioration pattern comprises stresses or fatigue of bridge elements.

4. The system of claim 1, further comprising a database for storing sensor data acquired from the one or more weight sensors.

5. The system of claim 4, wherein the real-time sensor data is transmitted to the computer from the database.

6. The system of claim 4, wherein the database stores indications when the weight of a vehicle exceeds the threshold value for the physical bridge.

7. A system comprising:
a computer executing a digital model of a physical bridge that is in use for carrying vehicular traffic;
one or more weight sensors positioned on the physical bridge or positioned on a road that leads to an entrance to the physical bridge;
a control system that is communicatively coupled to the one or more weight sensors and a closable gate positioned on an entrance to the physical bridge or positioned on the road that leads to the entrance to the physical bridge;
wherein the control system is configured to close the gate when the one or more weight sensors detects that a weight of a vehicle approaching the physical bridge exceeds a threshold value for the physical bridge; and
wherein the computer is configured to receive real-time sensor data acquired from the one or more weight sensors and to predict, using artificial intelligence, that the physical bridge is at risk of failure based on weight data of vehicles that have traveled over the physical bridge.

8. The system of claim 7, wherein the control system is configured to reroute or stop traffic on the physical bridge in response to receiving the prediction for the physical bridge.

9. The system of claim 7, further comprising a database for storing sensor data acquired from the one or more weight sensors.

10. The system of claim 9, wherein the real-time sensor data is transmitted to the computer from the database.

11. The system of claim 9, wherein the database stores indications when the weight of a vehicle exceeds the threshold value for the physical bridge.

12. A method comprising:
executing, by a computing device, a digital model of a physical bridge that is in use for carrying vehicular traffic;
communicatively coupling a control system to one or more weight sensors that are positioned on the physical bridge or on a road that leads to an entrance to the physical bridge;
receiving, by the control system, real-time sensor data acquired from the one or more weight sensors; and
causing, by the control system, an alert to be displayed on a digital sign at the entrance to the physical bridge or on the road that leads to the entrance to the physical bridge when the one or more weight sensors detects that a weight of a vehicle approaching the physical bridge exceeds a threshold value for the physical bridge.

13. The method of claim 12, further comprising:
predicting, by the computing device, a deterioration pattern for the physical bridge, using the digital model of the physical bridge; and
sending, by the computing device, the prediction to the control system.

14. The method of claim 13, wherein the control system is configured to reroute or stop traffic on the physical bridge in response to receiving the prediction for the physical bridge.

15. The method of claim 12, wherein the deterioration pattern comprises stresses or fatigue of bridge elements.

16. The method of claim 12, further comprising storing sensor data acquired from the one or more weight sensors in a database.

17. The method of claim 16, wherein the real-time sensor data is transmitted to the computing device from the database.

18. The method of claim 16, wherein the database stores indications when the weight of a vehicle exceeds the threshold value for the physical bridge.

19. The method of claim 12, wherein the control system is configured to close a gate to the entrance to the bridge when the one or more weight sensors detects that a weight of a vehicle approaching the physical bridge exceeds a threshold value for the physical bridge.

20. The method of claim 19, wherein the computer is configured to receive real-time sensor data acquired from the one or more weight sensors and to predict, using artificial intelligence, that the physical bridge is at risk of failure based on weight data of vehicles that have traveled over the physical bridge.
